(19) United States
(12) Patent Application Publication
(10) Pub. No.: US 2016/0153132 A1
(43) Pub. Date: Jun. 2, 2016

(54) METHOD FOR DISPLAYING WASH CYCLE

(71) Applicant: LG ELECTRONICS INC., Seoul (KR)

(72) Inventors: Jina LEE, Seoul (KR); Juhyung SHIN, Seoul (KR); Jungin PARK, Seoul (KR); Sooyoung YANG, Seoul (KR); Hyesoo KONG, Seoul (KR); Jeonghwa YANG, Seoul (KR); Eungyeong GWON, Seoul (KR)

(73) Assignee: LG ELECTRONICS INC., Seoul (KR)

(21) Appl. No.: 14/894,590

(22) PCT Filed: May 28, 2014
(86) PCT No.: PCT/KR2014/004748

§ 371 Date: Nov. 30, 2015

(30) Foreign Application Priority Data
May 30, 2013 (KR) 10-2013-0061766
Jul. 29, 2013 (KR) 10-2013-0089776

(51) Int. Cl. D06F 39/00; G06T 15/60; G06T 15/80; G06T 19/20

(52) U.S. Cl. CPC D06F 39/005; G06T 19/20; G06T 15/60; G06T 15/80; G06T 2219/2021

(57) ABSTRACT

A method for displaying a wash cycle comprises sequentially outputting a plurality of images depicting the current course or cycle and having different shapes, wherein each of the plurality of images includes a plurality of particles and the plurality of images represent an operation related to the current course or cycle through the plurality of particles. The plurality of images may represent a movement related to the current course or cycle by changing one of the number, size, position, and density of the particles in each image. Accordingly, the current washing status can be displayed vividly and vibrantly through a display screen with large screen size and high resolution.

### TECHNICAL FIELD

The present invention relates to a method for displaying a wash cycle, and more particularly, to a method for vividly displaying the current operating status of a home appliance, such as a washing machine or drying machine, that carries out a dynamic operation.

### BACKGROUND ART

A washing machine is an appliance that removes contaminants stuck to laundry by using emulsification of detergent, friction of a water stream caused by the rotation of a wash tub or washing blades, and impact applied to the laundry. The washing machine automatically carries out one or more of a series of wash, rinse, spin-dry, and dry cycles.

An operation part and a display part are installed at the front of the washing machine to set up operating conditions such as the amount of laundry, water level, washing intensity, number of runs of the rinse cycle, drying time, etc and display the current operating status when selecting one of many courses consisting of all or some of the washing, rinsing, spin-drying, and drying processes or carrying out each process or course.

As a washing machine offers many options to select or set, a knob (or dial) for selecting one of many courses, a plurality of buttons for setting various options, and a display for displaying the options and statuses set up for these options are laid out on the front of the washing machine in a complicated and disorganized manner, and only text information like the current ongoing state and the time remaining is displayed on a small-sized display screen or in the form of LED flashers.

With the widespread of smart devices such as smartphones or smart players, home appliances like washing machines and refrigerators tend to come with a neat design on the front in a similar fashion to the interface of a smart device, that is, by employing a touchscreen where input and screen output are both done.

Although a home appliance with a touchscreen employed in it has larger screen size and higher resolution than in the prior art, simply delivering the current washing status or the time remaining in text cannot make full use of the merits such as large screen size and high resolution.

### DISCLOSURE OF INVENTION

### Technical Problem

The present invention has been made in view of the above circumstance, and an aspect of the present invention is to provide a method for vividly and efficiently showing ongoing statuses associated with washing machine's operations.

Another aspect of the present invention is to provide a display method which allows a user to intuitively find out the current ongoing status related to washings.

### Solution to Problem

An exemplary embodiment of the present invention provides a method for displaying a wash cycle, the method sequentially outputting a plurality of images depicting a current course or a current cycle and having different shapes, each of the plurality of images including a plurality of particles, the plurality of images representing an operation related to the current course or cycle through the plurality of particles.

The plurality of images may represent a movement related to the current course or cycle by changing the number, size, position, and density of the particles in each image.

Each of the plurality of images may be displayed within a circle.

The plurality of images each may contain grid dots as the background.

The grid dots may be displayed darker than the plurality of particles.

The grid dots near the center of an image may be displayed sharper than the grid dots on the outer part of the image.

The grid dots may be displayed within a three-dimensional water drop, and a change in the three-dimensional shape of the water drop may be represented by varying the intervals between the grid dots.

One or more of the plurality of images may contain text indicative of the current course or cycle.

When two or more of the plurality of images contain text, the text in the two or more images may differ in lightness.

The text may be displayed within a three-dimensional water drop, and a change in the three-dimensional shape of the water drop may be expressed by distorting a part of the text.

One or more images each containing an icon associated with the current course or cycle and the plurality of images showing the plurality of particles may be cyclically output.

Two or more images each containing the icon may be sequentially output, and the icon in any image may be more blurry than the icon in the preceding image.

One or more first images showing the plurality of particles which are arranged output around the blurred icon may be output, and then one or more second images containing no icon and showing the plurality of particles may be output, wherein the plurality of particles in each of the first and second images may form a predetermined pattern to depict the operation related to the current course or cycle.

One of the plurality of images and a remaining time may be displayed together on a single screen.

The plurality of images may are represented such that the plurality of particles are arranged within a three-dimensional water drop.

The three-dimensional shape of the water drop may be expressed by the surface gloss, shadow, or outline of the water drop.

A change in the three-dimensional shape of the water drop may be expressed by changing at least one of the following: surface gloss, shade, shadow, degree of particle scattering, and outline.

The operation related to the current course or cycle may be dynamically displayed by adding one or more second water drops smaller than the water drop or changing the number, size, or position of the one or more second water drops.

### Advantageous Effects of Invention

Accordingly, the user can intuitively find out a washing status.

Moreover, the current washing status can be displayed vividly and vibrantly through a display screen with large screen size and high resolution.

In addition, input/output devices of a home appliance have integrity with those of a smart device, and the home appliance has a neat appearance.

### BRIEF DESCRIPTION OF DRAWINGS

FIG. 1 illustrates a perspective view of a drum washing machine and an enlarged view of an operation part and a display part.

FIG. 2 is a cross-sectional view showing an internal structure of the drum washing machine.

FIG. 3 is a cross-sectional view showing an internal structure of a top-loading type washing machine.

FIG. 4 illustrates the configurations of blocks that operate to perform the functions of a washing machine.

FIG. 5 illustrates wash, rinse, and spin-dry cycles run by the washing machine.

FIG. 6 illustrates an output screen displaying the current status and the time remaining according to an exemplary embodiment of the present invention.

FIGS. 7 to 14 illustrate an exemplary embodiment in which a plurality of images each containing an icon and showing the movement of particles are consecutively displayed to dynamically display the current status.

FIG. 15 illustrates an output screen displaying the current status and the time remaining according to another exemplary embodiment of the present invention.

FIGS. 16a to 16j illustrate an exemplary embodiment in which a plurality of images each showing the three-dimensional shape of a water drop that organically changes with the movement of particles or the movement of air are consecutively displayed to dynamically display the current status.

### BEST MODE FOR CARRYING OUT THE INVENTION

Hereinafter, a method for displaying a wash cycle according to the present invention will be described with reference to the accompanying drawings.

Washing machines may be classified into a washing machine that removes contaminants on laundry such as clothing by the action of detergent and water, a drying machine that dries laundry with hot air, and a washer-dryer machine that performs both wash and dry in a single system, depending on their functionality.

Also, washing machines may be classified into a top-loading type machine that has a vertically mounted wash tub (or inner tube or drum) to load laundry from the top and rotates around a vertical axis and a front-loading type machine that has a horizontally mounted wash tub to load laundry through the front and rotates around a horizontal axis, depending on their structure.

The top-loading type machine may be classified into an agitator-type machine that performs wash by rotating an agitator rising from the center of the wash tub and a pulsator-type machine that performs wash by rotating a disc-shaped pulsator mounted below the wash tub or the wash tub. The front-loading type machine is commonly called a drum washing machine that has a lift placed on the inner peripheral surface of the drum which constitutes the wash tub and performs wash by lifting up laundry and dropping it by the lift as the drum rotates.

As described above, there are various types of washing machines, any of which has a water supply unit for supplying wash water into a water storage tank (or outer tank or tub) or the wash tub (or inner tank or drum) and a drainage unit for draining wash water from the outer tank after performing wash, rinse, and spin-dry actions.

Unless otherwise specified, exemplary embodiments of the present invention may apply to all of the above-mentioned machines.

First of all, the structure of a washing machine will be described.

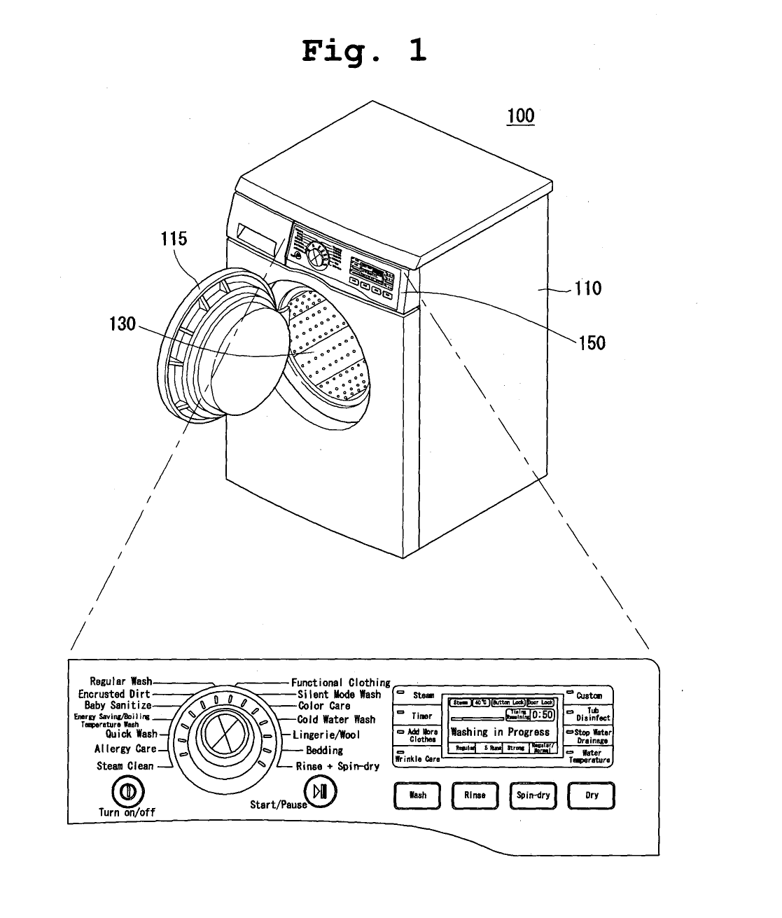

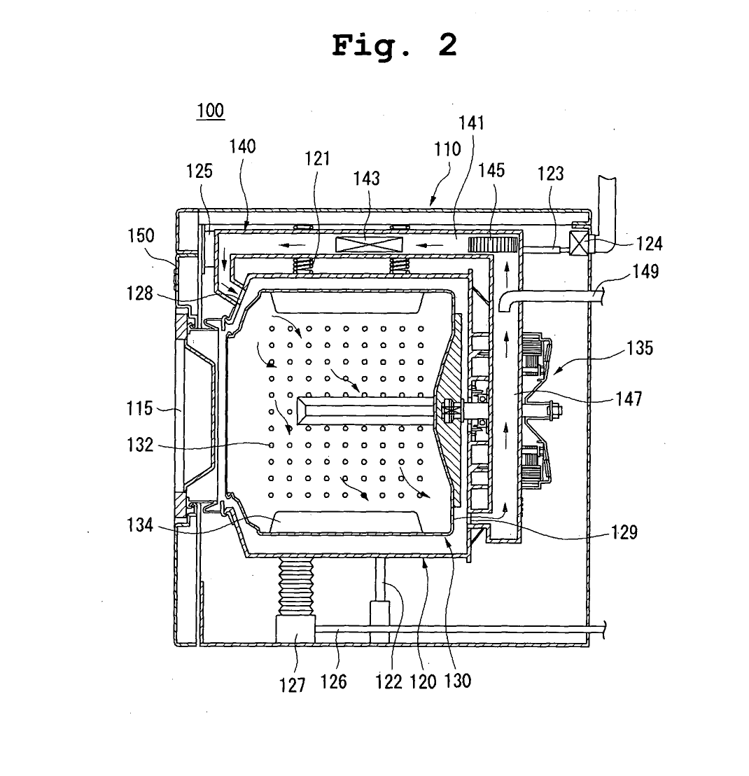

FIG. 1 illustrates a perspective view of a drum washing machine and an enlarged view of a manipulation part and a display part. FIG. 2 is a cross-sectional view showing an internal structure of the drum washing machine.

A washing machine 100 includes a cabinet 110 forming the outer appearance, a rotatable door 115 at the front to load laundry, a water storage tank (tub or outer tank) 120 provided inside the cabinet 110 and containing wash water, a wash tub (drum or inner tank) 130 containing laundry in the water storage tank 120 and being rotatable, a driving unit 135 for applying torque to the wash tub 130 and washing, rinsing, and spin-drying the laundry loaded into the wash tub 130, an operation panel 150 for receiving various instructions for operating the washing machine from the user and indicating the operating status of the washing machine, and a controller (not shown) for controlling each of the components and operating the washing machine 100. The washing machine 100 with drying functionality may further include a dryer.

The water storage tank 120 is connected to the cabinet 110 through springs 121 in the upper portion and a damper 122 in the lower portion and reduces the vibration caused by the rotation of the wash tub 130 transmitted to the cabinet 110.

Above the water tank 120 are a water supply path 123 for supplying water from the outside into the tub 130, a water supply valve 124 mounted on the water supply path 123 to control the passage of water, and a detergent supply unit 125 for putting detergent, together with water supplied through the water supply path 123, into the water tank 120. Below the water tank 120 are a drainage path 126 and a drain pump 127 for draining out the wash water used for washing, rinsing, etc.

A plurality of holes 132 through which wash water passes are formed in the wash tub 130, and a plurality of lifts 134 for lifting up and then dropping the laundry loaded in the wash tub 130 when the wash tub 130 rotates are formed inside the wash tub 130. As laundry is moved by the lift 134, high washing performance can be achieved.

The washing machine 100 with drying functionality may have a circulating duct 140 for circulating air for a drying cycle mounted outside the water storage tank 120. The circulating duct 140 is configured to draw air from inside the water storage tank 120, heat the air, and blow it into the water storage tank 120.

The circulating duct 140 is divided into a drying duct 141 and a condensation duct 147, and a heater 143 and a blower fan 145 are mounted inside the drying duct 141 to blow hot air out into the water storage tank 120. An inlet port 128 for letting hot air in through the drying duct 141 and an outlet port 129 for letting air out to the condensation duct 147 are formed in the water storage tank 120. Moreover, a water feeder 149 for supplying cooling water is mounted at the condensation duct 147 to condensate moisture in the air.

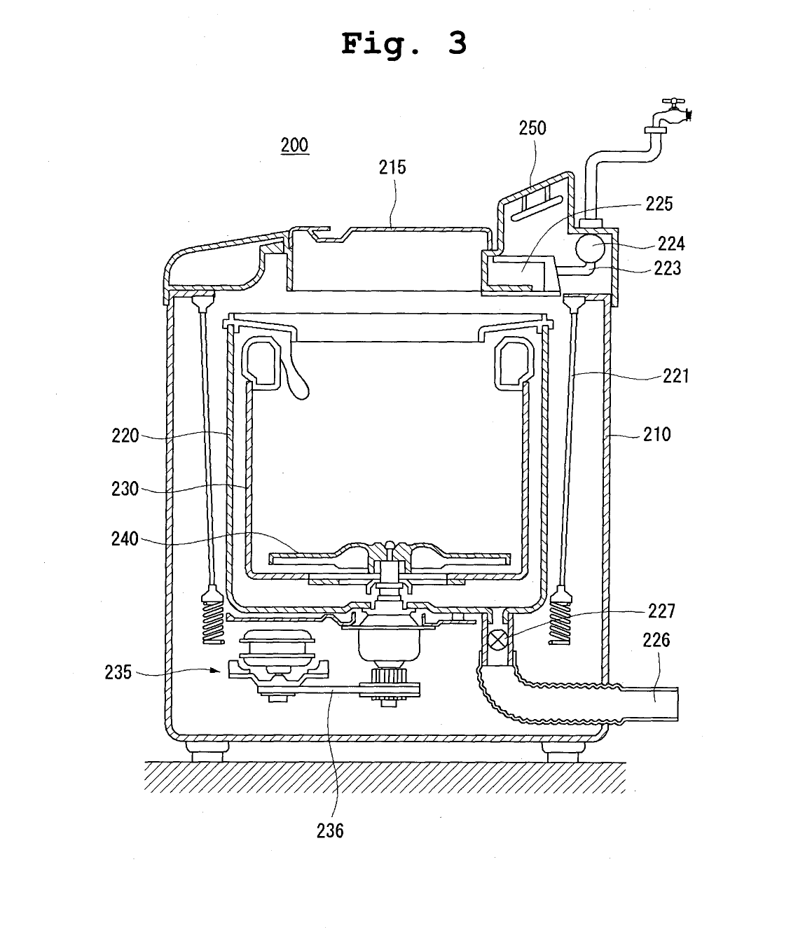

FIG. 3 is a cross-sectional view showing an internal structure of a top-loading type washing machine.

A washing machine 200 of FIG. 3 may include a cabinet 210 forming the outer appearance, a door 215 for opening closing a laundry loading port, a water storage tank 220 placed within the cabinet 210 to contain wash water, a wash tub 230 rotatably provided to contain laundry within the water storage tank 220, an actuator 235 for rotating the wash tub 230 or a pulsator (or rotating blade) 240 through a power transmitting means such as a belt 236, and an operation panel 250 including an input part for receiving instructions and a display part for indicating the operating status of the washing machine.

Two or more suspensions 221, such as springs, for suspending the water storage tank 220 on the top cover of the cabinet 210 may be provided to absorb vibration that is generated when the wash tub 230 rotates.

A water supply path 223, a water supply valve 224, and a detergent box 225 serve as a water supply unit for supplying water to the water storage tank 220. Water is let in through the water supply path 223 connected to an external water resource like a tap, and the water flowing through the water supply path 223 is mixed with a detergent contained within the detergent box 225 and additives such as a fabric softener or bleach and supplied as wash water into the wash tub 230.

A drainage path 226 and a drain pump 227 serve as a drainage unit for draining the wash water in the water storage tank 220 for draining out the wash water used for washing, rinsing, etc. The wash water in the water storage tank 220 may be drained out through the water supply path 226 when the water supply valve 227 is opened, or may be pumped by a drain pump (not shown) provided on the drainage path 226.

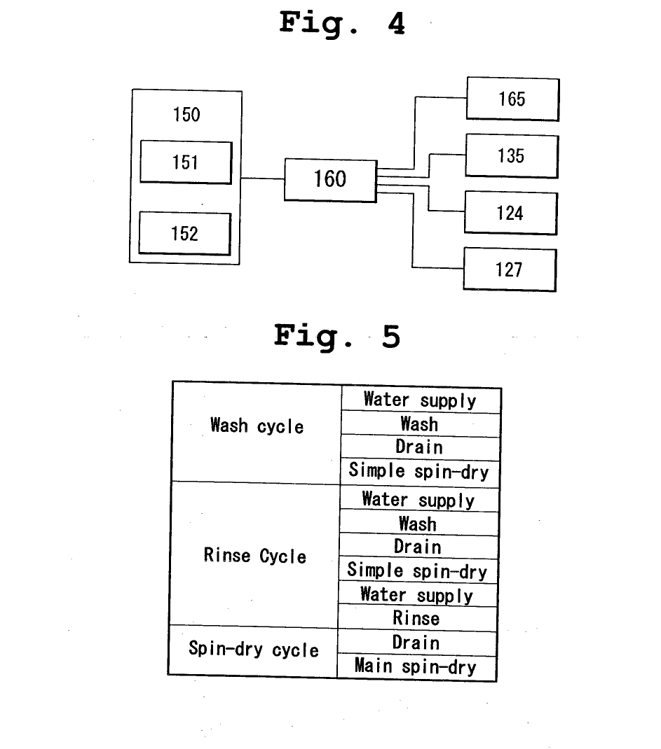

FIG. 4 illustrates the configurations of blocks that operate to perform the functions of a washing machine.

The washing machine 100 may include a controller 160 for regulating the wash cycle of the washing machine and controlling the options, an actuator 135 for rotating the wash tub 130 under the control of the controller 160, a water supply valve 124 for supplying water to the water storage tank 120, a drain pump for draining out the wash water in the water storage tank 120, a sensor 165 such as a laundry amount sensor for sensing the amount of laundry contained in the wash tub 130 loaded in the wash 130, a water level sensor for measuring the water level in the wash tub, a temperature sensor, a vibration sensor, etc, and an operation panel 150 including an input part 151 for receiving user instructions to select operations of the washing machine and an output part 152 for outputting various washing information such as the operating status of the washing machine or the time remaining as sound or on the screen. The controller 160 may be mounted on a board where the operation panel 150 is attached.

The controller 160 controls the overall operations of the washing machine according to instructions input through the input part 151. The controller 160 determines whether to carry out each cycle or not, and which of the actions like water supply, wash, rinse, drain, spin-dry, and dry should be done in each cycle and how long and how many times the actions should be run according to the optimum washing pattern or course automatically set based on the type and amount of laundry and how dirty the laundry is or according to a washing course selected by the user, and performs each action as determined.

The controller 160 may incorporate storage (not shown) such as a nonvolatile memory that stores laundry type information and washing methods. The storage may store information on materials, fabrics, etc for various types of clothing in a database, prestore the optimum washing pattern for each laundry type, that is, the method, sequence, length of time, number of runs, etc for washing, rinsing, spin-drying, etc and further store a program for actuating the washing machine and information related to the cycles of washing, drying, spin-drying, etc.

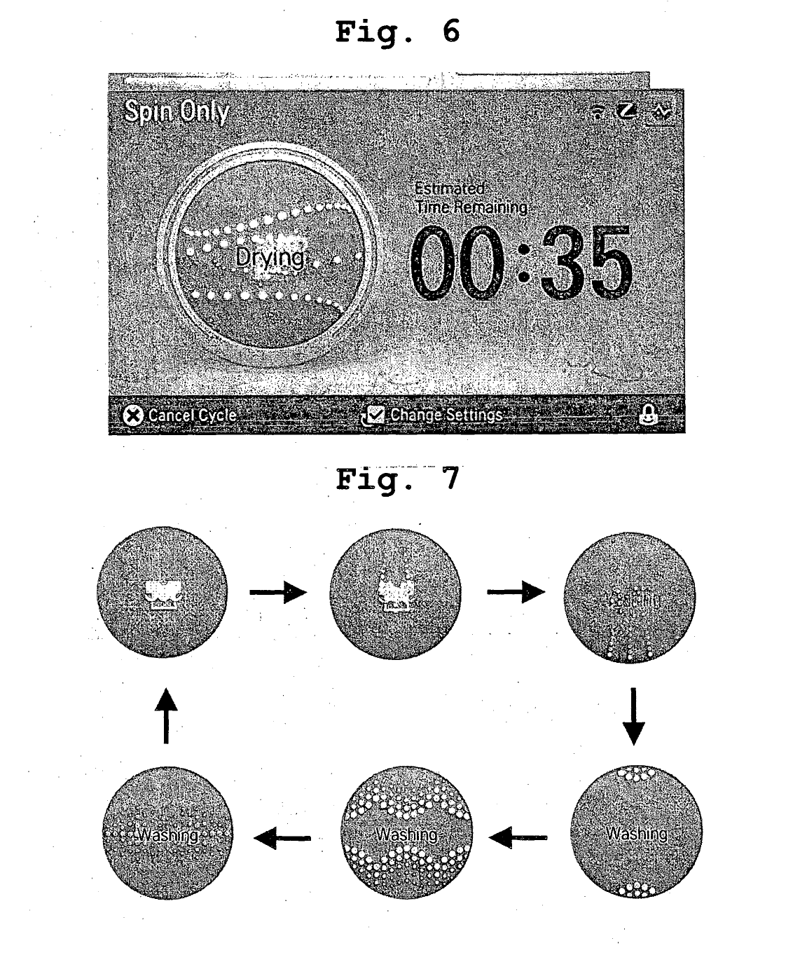

FIG. 5 illustrates wash, rinse, and spin-dry cycles run by the washing machine.

A wash cycle is a cycle in which contaminants are removed from laundry by soaking the laundry in wash water mixed with a detergent and rotating the wash tub 130. The wash cycle is run in the order of water supply, wash, drain, and simple spin-dry. The wash cycle may further include a laundry distribution process to prevent laundry from being one-sided within the wash tub 130.

When the wash cycle begins, the controller 160 may display through the output part 152 that the wash cycle is in progress.

Water supply involves supplying water from an external water supply source (tap) into the water storage tank 120.

When the water storage tank 120 is filled with water up to a target water level, the controller 160 shuts off the water supply valve 124 to complete water supply.

Washing involves actuating the actuator 135 to rotate the wash tub 130 containing the laundry soaked in wash water mixed with a wash detergent. During washing, the controller 160 may control the actuator 135 to rotate the wash tub 130 at different speeds or directions and stop the operation of the actuator 135 at intervals of a few seconds or minutes in order to prevent overheating.

Draining involves draining the wash water in the water storage tank 120 out of the cabinet 110. The controller 160 operates the drain pump 127 (or drain valve) so that the wash water in the wash tub 130 is let out through the drainage path 126.

Simple spin-dry involves rotating the wash tub 130 at high speeds to make the wash water exit from the laundry. The controller 160 may intermittently operate the drain pump 127 during the simple spin-dry process so that the wash water in the water storage tank 120 is let out through the drainage path 126.

A laundry distribution process involves distributing laundry by changing the rotation speed of the wash tub 130, i.e., inducing repeated accelerations and decelerations in rotation speed.

A rinse cycle is a cycle in which the detergent remaining on laundry is removed by soaking laundry in wash water mixed with fabric softener and then rotating the wash tub 130. Rinsing may be done twice in the order of water supply, rinse, drain, simple spin-dry, water supply, and rinse. Otherwise, rinsing may not be done or may be done three times or more.

When the rinse cycle begins, the controller 160 may display through the output part 152 that the rinse cycle is in progress.

The laundry distribution process may be done once again at the end of the rinse cycle.

The spin-dry cycle is a cycle in which water is removed from laundry by rotating the wash tub 130 at high speeds, which may include draining and main spin-dry.

When the spin-dry cycle begins, the controller 160 may display through the output part 152 that the spin-dry cycle is in progress. Main spin-dry involves rotating the wash tub 130 at high speeds, faster than the simple spin-dry step in the wash cycle or rinse cycle, to make the wash water exit from the laundry, and intermittently operating the drain pump 127 so that the wash water in the water storage tank 120 is let out through the drainage path 126.

The washing machine with a drying function may further run a dry cycle for drying laundry by supplying hot air into the wash tub 130 after the main spin-dry step.

In recent years, the laundry capacity of washing machines has been increasing and the technology of controlling the rotation of the wash tub has been developed, this allows adding many functions, e.g., dry, steam, and water stream control, to the washing machines, offers various wash courses, and allows the user to select or set a larger number of options for each of the wash, rinse, spin-dry, and dry cycles.

New machines of larger capacity come with many preprogrammed courses, including Regular Wash, Functional Clothing, Silent Mode Wash, Color Care, Lingerie/Wool, Bedding, Rinse+Spin-dry, Steam Clean, Allergy Care, Quick Wash, Energy Saving/Boiling Temperature Wash, Baby Sanitize, and Encrusted Dirt. When the user selects one of these courses, all or some of the wash, rinse, spin-dry, and dry cycles are automatically run according to the selected course.

When selecting and running the wash cycle, the user may select one of the options including Steam Wash, Soak, Pre-wash, Strong, Normal, and Weak and the optimal wash action and the subsequent rinse and spin-dry actions may be performed according to the selected option. The dry cycle has the options including Jeans, Cotton/Towels, Regular Dry, Synthetic, Shirts, Lingerie, Quick Dry, Cooling, Shoes, Wrinkle Care Dry, Sanitize, and Set Timer for Damp Dry for Ironing from which the user can select one.

As washing machines offer more courses for wash and dry, the user interfaces of the input part and output part where the user can choose one of the courses using a dial have to indicate all of these courses around the dial, which makes the user interfaces look complicated. Therefore, it is not easy to tell which course has been selected when viewed from a distance, and the size of text displayed within a small display is limited, making it difficult to identify the selected course or the current cycle on the display.

Input/output devices with a similar interface to the interface of a smart device, which have been put into use in keeping with the recent trend, are capable of providing various information using graphics and animations, as well as text, because they have a large display screen and high resolution.

Accordingly, a preprogrammed course or the current operation step (cycle) can be vividly displayed on the large-sized output screen of a display device with both user input and output functions by using animations or video. The icons associated with courses or cycles may be displayed to allow the user to intuitively know which course is being run or how the current cycle is running, and the features of these courses or cycles can be dynamically displayed based on the movement of particles.

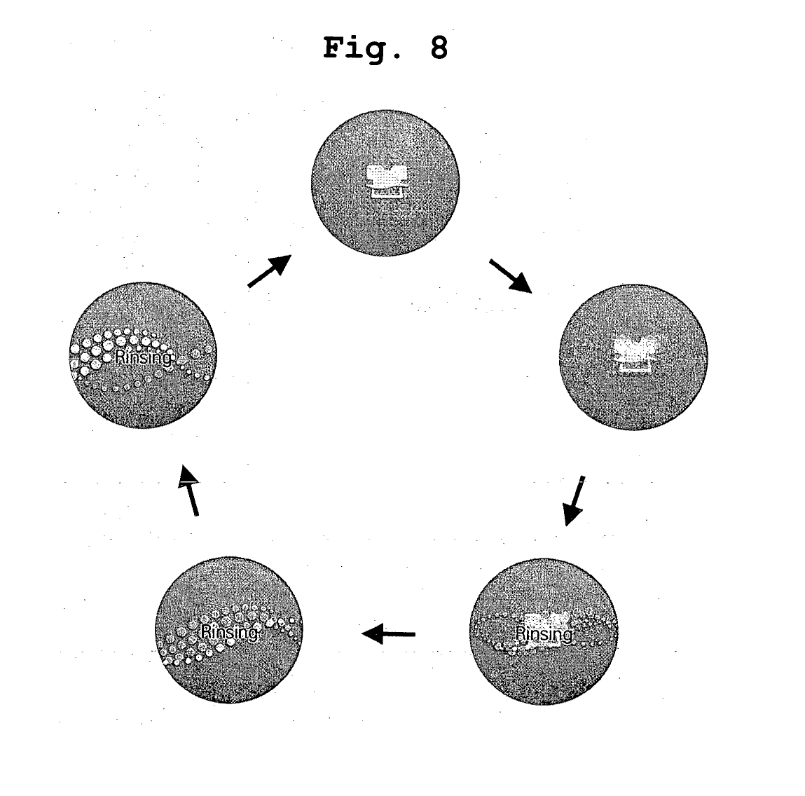

FIG. 6 illustrates an output screen displaying the current status and the time remaining according to an exemplary embodiment of the present invention.

In FIG. 6, consecutive images containing text, icons, an animation, etc and depicting the current status are displayed within a circle on the left side that symbolizes the wash tub, the time remaining is displayed on the right side, and texts or areas associated with instructions for stopping the current cycle or change the settings are displayed in the box below.

A touch screen used for a smart device is able to display images, animations, or video, as well as text, because it offers a high-resolution display. Therefore, the present invention is applied to a washing machine or drying machine using a high-resolution touch screen, and images or animations can be output through a large-sized, high-resolution display to vividly display each operation step, thereby stirring the user's visual senses.

The current operation step (or cycle) or a course selected by the user (or automatically) can be delivered in a video or animation format in which an image continuously changes, as well as in an image containing text and/or graphics (icon). Using the icon, text, and animation showing the movement of particles, the current cycle can be illustrated, or the operation of the current cycle can be visually displayed.

The current cycle can be displayed in an animation showing the movement of particles by sequentially outputting an image of an icon indicating the current cycle, an image of particles appearing near the icon as the icon becomes blurry, and a plurality of images showing the current cycle in a predetermined pattern of particles after the icon disappears, within a circle, which is the shape of the washing machine when viewed from the top. By adding text to an image with a predetermined pattern of particles, the current cycle can be displayed more clearly.

The operation of the current cycle may appear in between the sequentially-displayed images showing particles by changing at least one of the number, size, position, and density of the particles in each image.

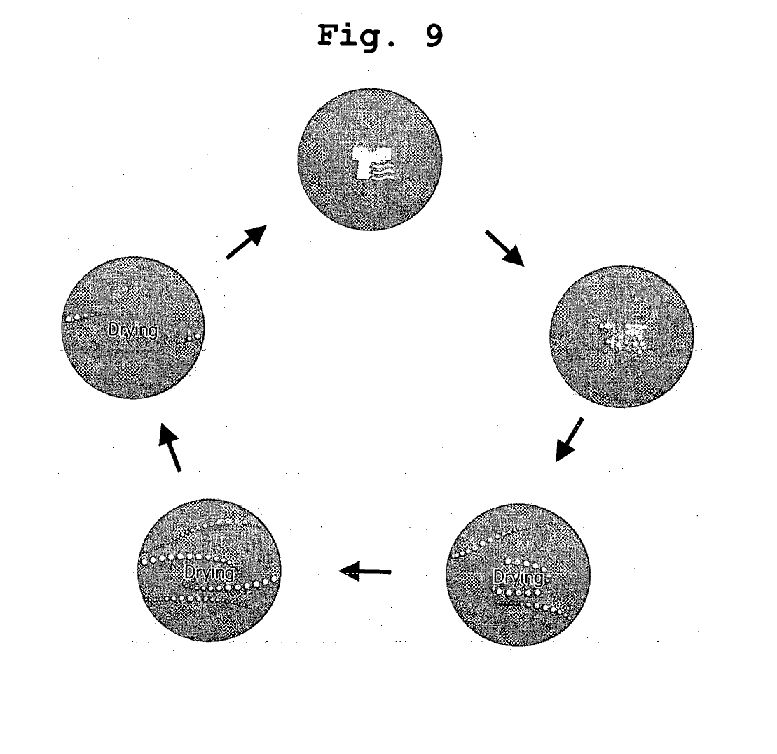

FIGS. 7 to 14 illustrate an exemplary embodiment in which a plurality of images each containing an icon and showing the movement of particles are consecutively displayed to dynamically display the current status.

FIG. 7 illustrates a plurality of images of the wash cycle. Each image contains grid dots as the background and an overlying icon or particles, the grid dots being displayed within a circle symbolizing the tub, and the icon or particles being lighter than the grid dots. The dim grid dots make the area around the circle symbolizing the tub look sharper than the outer part of the circle, bringing the center of the circle into visual focus.

The first image may contain an icon displayed in the center to indicate laundry soaked in slopping wash water, the second image may show a plurality of semitransparent particles of different sizes appearing near the icon as if wash water for a wash is poured onto the laundry from the top, and the third to sixth images may show the particles scattering and fluctuating up and down as the icon disappears. Text indicative of wash may be added to the image with the icon gone, and text may differ in lightness from image to image. The six images of FIG. 7 are sequentially displayed, and the first image is cyclically displayed after completion of the display of the sixth image.

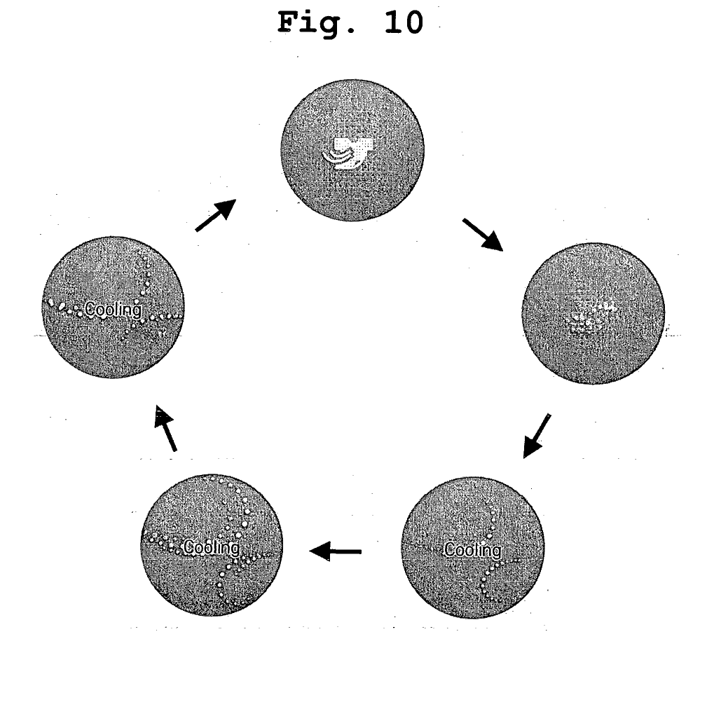

FIG. 8 illustrates a plurality of images of the rinse cycle. Like in FIG. 7, each image contains dark grid dots as the background and an overlying icon or particles, the grid dots being displayed within a circle symbolizing the tub, and the icon or particles being lighter than the grid dots.

The first image may contain an icon displayed in the center to indicate laundry soaked in wash water slopping more gently than in the wash cycle, the second image may show a plurality of semi-transparent particles of different sizes appearing near the icon as if wash water for a rinse is creating waves around the laundry, and the third to fifth images may show the particles fluctuating horizontally as the icon disappears. Like in FIG. 7, text indicative of wash may be added to the image with the icon gone, and text may differ in lightness from image to image.

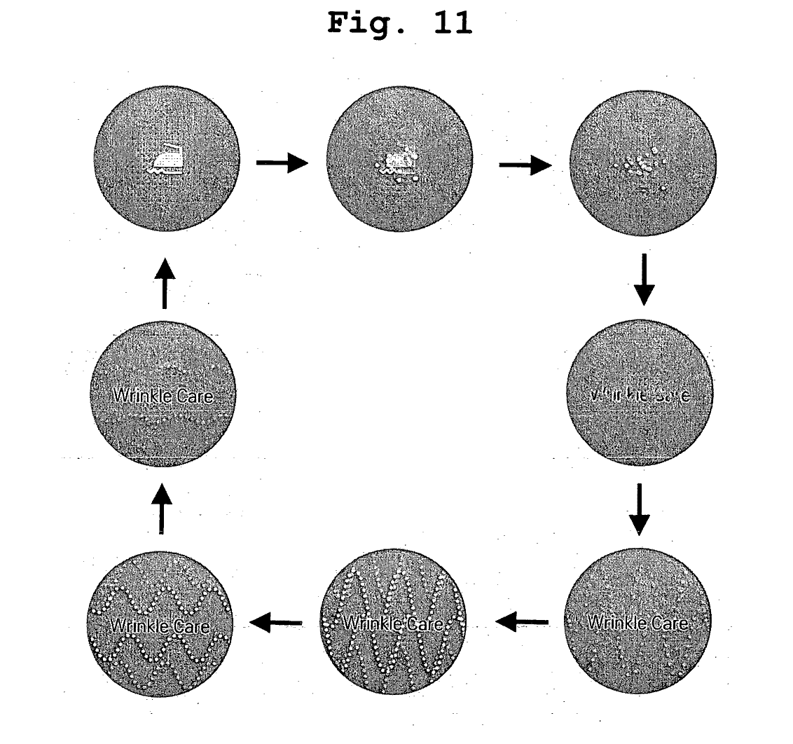

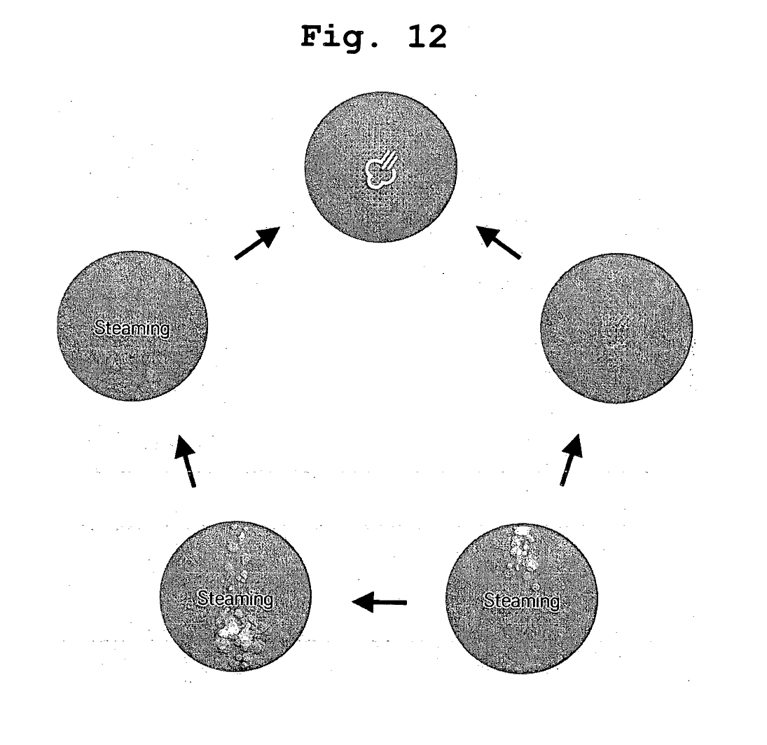

FIGS. 9 and 10 illustrate a plurality of images of the dry cycle and a plurality of images of the cooling cycle, respectively. Each image contains an icon of laundry being blown by air after the wash, rinse, and spin-dry cycles. In the dry cycle, the movement of particles may be expressed by an image of hot air, and in the cooling cycle, the movement of particles may be expressed by an image of air at ambient temperature where the dry heater does not operate.

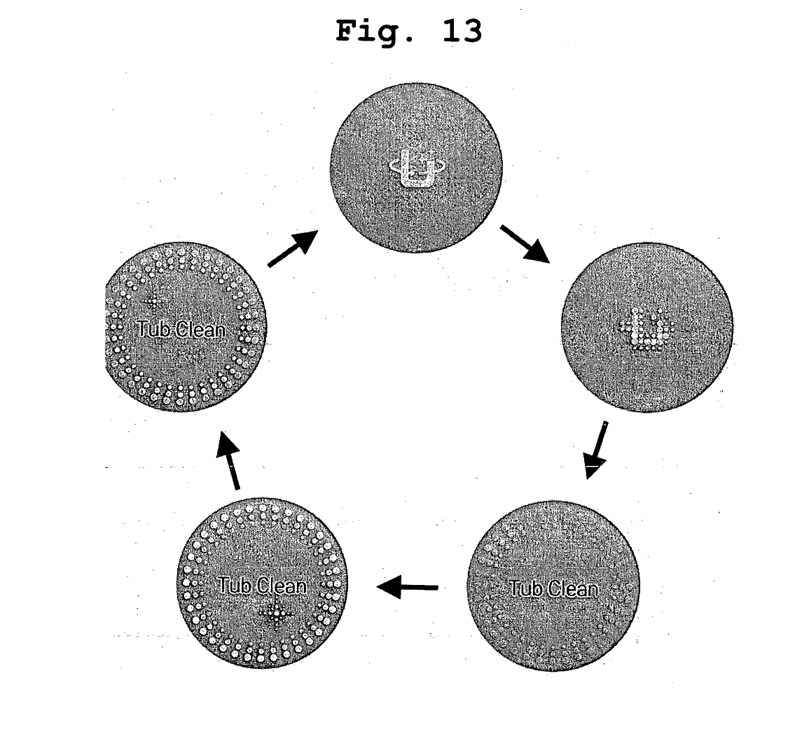

FIG. 11 illustrates a plurality of images of the wrinkle care cycle. The wrinkle care function is a function for preventing wrinkles by periodically rotating the drum if the user has not taken washed or dried laundry out while the user is out or the like after completion of drying.

The wrinkle care course can be expressed by an icon of partially-wrinkled laundry placed under an iron, and consecutive images can be output to indicate that the wrinkles decrease with the gradually decreasing amplitude of a sine-wave pattern of particles.

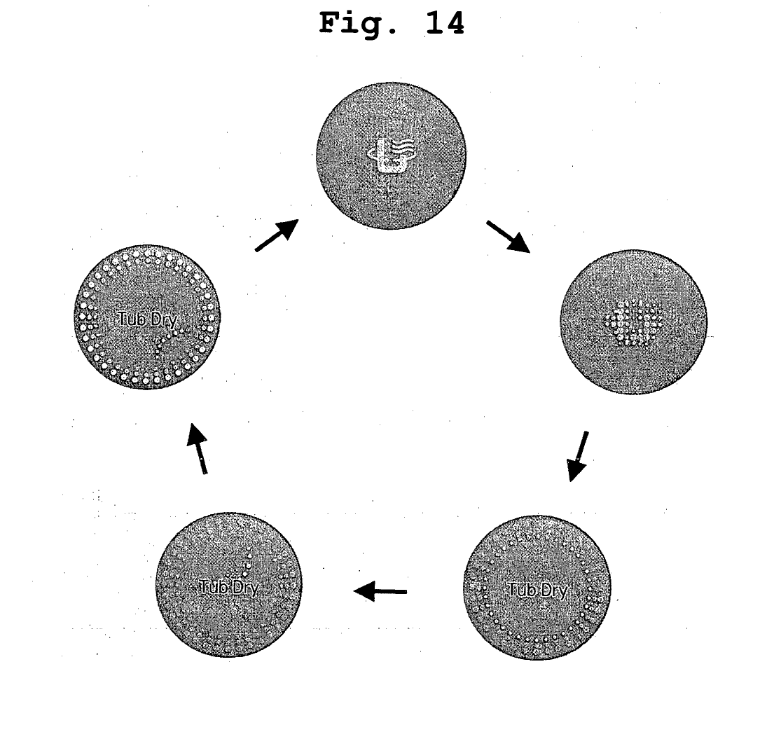

FIG. 12 illustrates a plurality of images of the steam cycle. The steam cycle is used when the user wants to remove encrusted dirt or sanitize underwear or clothing. The steam cycle can be expressed by an icon of a cloud of steam, which is output in consecutive images to indicate that steam is given off from top to bottom.

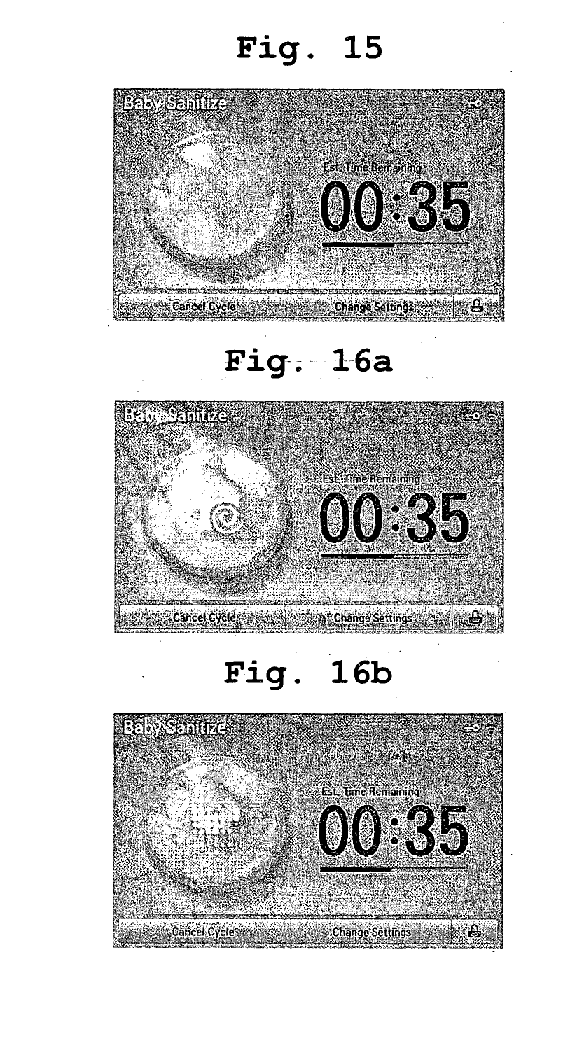

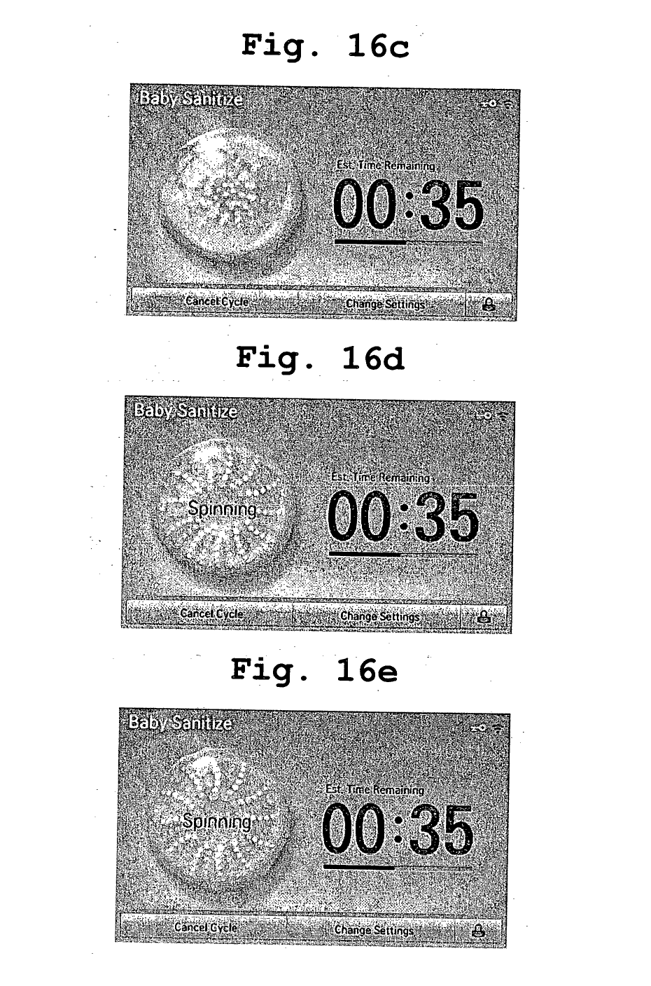

FIGS. 13 and 14 illustrate a plurality of images of the tub clean cycle and a plurality of images of the tub dry cycle, respectively. The tub clean cycle and the tub dry cycle involve cleaning the inside of the washing machine of any bacteria to keep the wash tub clean and fresh.

The tub clean cycle can be expressed by an icon of a sparkling and rotating U-shaped tub, and the tub dry cycle may be expressed by an icon of hot air delivered to the rotating U-shaped tub. The tub clean cycle and the tube dry cycle are illustrated in consecutive images that are output to indicate that water is moving inward or outward as the brightness or density of particles arranged in a concentric pattern along the outer part of a circle changes in a radial direction. In the tub clean cycle, the sparkles on the tub are illustrated using the movement of particles, and in the tube dry cycle, the air blown into the tub is also illustrated using the movement of particles.

As illustrated in FIGS. 7 to 14, one or more of the plurality of images contain an icon associated with the current course or the current cycle, and two or more images show a plurality of particles. The particles in each image form a predetermined pattern, and consecutive images show the movement of the particles, thereby depicting the current course or the current cycle.

When displaying two or more consecutive images each containing an icon associated with the current course or the current cycle, the icon becomes blurry. The icon in any image is more blurry than the icon in the preceding image. Also, a plurality of particles may appear near the icons in some of the images that have been blurred.

Some of the plurality of particles forming a predetermined pattern and containing a plurality of images that illustrate the operation of the current course or cycle may further contain a blurred icon, and the others may contain no icon.

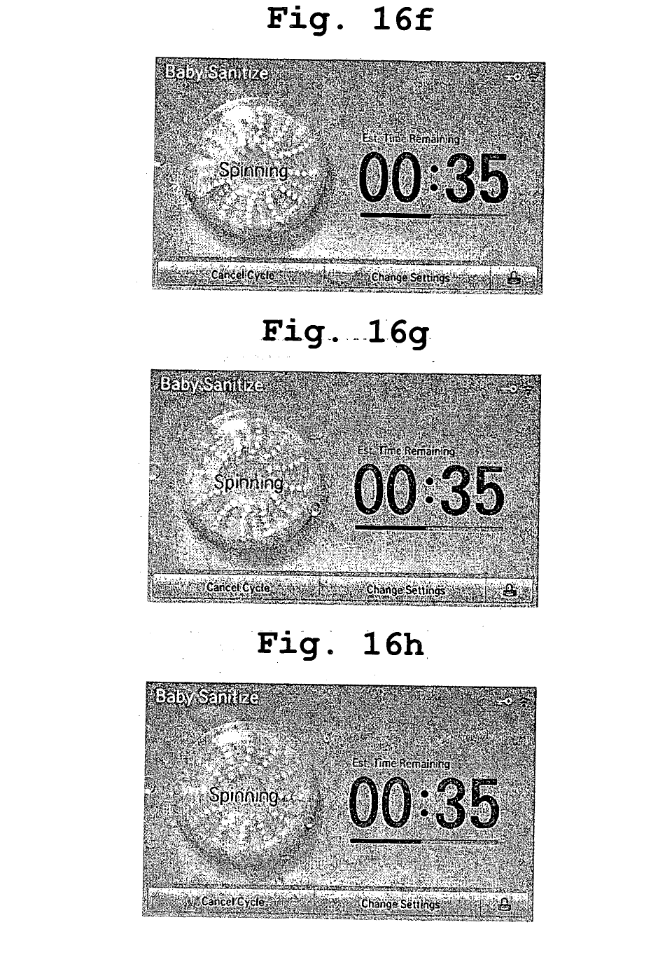

FIG. 15 illustrates an output screen displaying the current status and the time remaining according to another exemplary embodiment of the present invention. While the screen of FIG. 6 shows a consecutive image containing text, an icon, an animation, etc and depicting the current status that is displayed within a circle symbolizing the wash tub, FIG. 15 shows an image of a three-dimensional water drop on which light coming from the outside falls.

FIG. 15 illustrates the light coming through a window and casting a shadow next to a water drop, illustrates the three-dimensional shape of the water drop by the curve of the shadow on the water drop surface cast by the light coming through the window, illustrates the three-dimensional shape of the water drop by contrasting the highlight on the surface on which light falls with the shadow on the opposite side, and illustrates the three-dimensional shape of the water drop by the shadow on the opposite side of the surface on which light falls or the outline or shaded area of the water drop.

In this way, the three-dimensional shape of the water drop of FIG. 15 can be expressed by the surface gloss, shadow, or outline of the water drop, and a change in the three-dimensional shape of the water drop caused by the shaking of the washing machine or the air generated by a flow of washwater inside the washing machine can be expressed by changing the surface gloss, shadow, outline, or surface uniformity of the water drop.

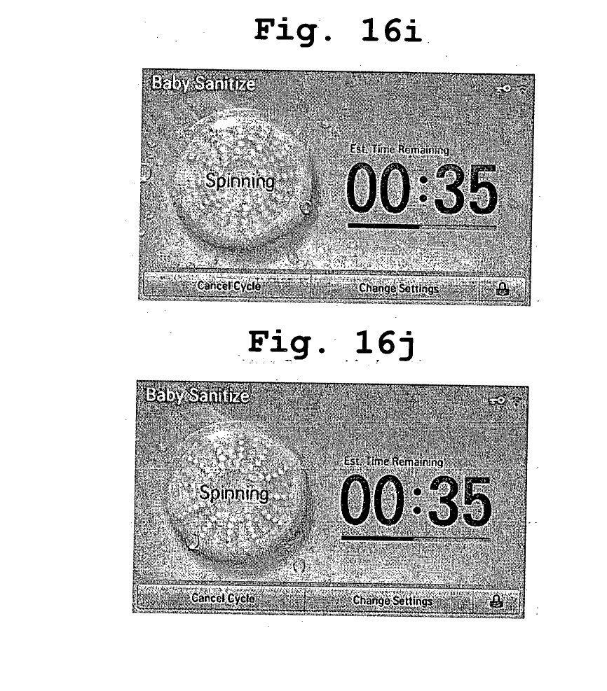

FIGS. 16a to 16j illustrate an exemplary embodiment in which a plurality of images each showing the three-dimensional shape of a water drop that organically changes with the movement of particles or the movement of air are consecutively displayed to dynamically display the current status. The spin cycle is expressed by a plurality of images showing the changing arrangement of particles and/or the changing three-dimensional shape of a water drop.

The light coming through a window is illustrated as casting shadows next to the water drop and the leaf, and the three-dimensional shape of the water drop is illustrated as having a curved distortion in the shadow of the window and the shadow of the leaf within the water drop. Also, the three-dimensional shape of the water drop can be expressed by varying the surface gloss, shadow, or outline of the water drop depending on the direction from which light enters.

The image of FIG. 16a shows a spiral-shaped icon symbolizing laundry and rotation within a three-dimensional water drop to indirectly describe a spin action, and the images of FIGS. 16b and 16c show that the dirt on the laundry is decomposed into a plurality of particles and spreads outward in radial directions by the initial rotation of the wash tub for spin-drying. The image of FIG. 16d shows that, as the wash tub rotates faster, the particles is spreading not in a linear fashion but in a curved fashion as far as the outer edge of the water drop and accordingly the water drop is vibrating and fluctuating, making the outline of the water drop uneven. The movement of the particles may vary from image to image by changing the number, size, position, and density of the particles in each image.

The images of FIGS. 16e to 16j illustrate a faster rotation speed of the wash tub by the shape of particles. The circular-shaped particles are illustrated as having an elliptical distortion along the rotating direction to show that the three-dimensional shape of the water drop is getting deformed and the surface of the water drop is getting non-uniform. Also, dynamic motions can be expressed by atomizing a big water drop into small water drops and changing the position, size, and number of the small water drops in each image. The small water drops are illustrated as being around, in, or over the big water drop in a three-dimensional configuration to show that wash water is removed from laundry as the wash tub rotates at high speeds.

Moreover, text can be inserted into the big water drop to indicate that the current cycle is the spin cycle. The text also looks distorted, rather than looking regular, to show that the three-dimensional shape of the water drop is changing. In addition, text may differ in lightness from image to image.

Similarly to the embodiment of FIGS. 7 to 14, each image contains dim grid dots as the background and an overlying icon or particles, the grid dots being displayed within a water drop, and the icon or particles being lighter than the grid dots. The dim grid dots make the area around the water drop look sharper than the outer part of the water drop, bringing the center of the water drop into visual focus. Moreover, a distortion or change in the three-dimensional shape of the water drop can be illustrated by varying the spacing between the grid dots.

The memory of the controller 160 stores image data constituting the output screen according to the present invention. The controller 160 may extract multiple image data for depicting the current cycle or course from the memory, and create an output screen containing images, text, etc based on the multiple image data and display it through the output part 152. A plurality of images depicting the current cycle may be sequentially and cyclically output.

The plurality of images of the cycles shown in FIGS. 7 to 16 are merely examples, and animations of other cycles or courses may be displayed.

Although FIGS. 6 to 16 only illustrate examples of displaying consecutive images each containing text, an icon, an animation, etc within a circle or a three-dimensional water drop to depict the current status or cycle, the present invention is not limited to these examples and the consecutive images can be displayed within a polygon such as a quadrangle, pentagon, or hexagon or within an ellipse as long as these shapes are fit for the display space where the consecutive images are to be displayed. In addition, the movement or arrangement of particles may be changed to be fit for the display space of the consecutive images.

The exemplary embodiments of the present invention described above have been provided for illustrative purposes. Therefore, those skilled in the art will appreciate that various modifications, alterations, substitutions, and additions are possible without departing from the scope and spirit of the invention as disclosed in the accompanying claims and such modifications, alterations, substitutions, and additions fall within the scope of the present invention.

1. A method for displaying a wash cycle, the method comprising sequentially outputting a plurality of images depicting a current course or cycle and having different shapes,
wherein each of the plurality of images includes a plurality of particles and the plurality of images represent an operation related to the current course or cycle through the plurality of particles, and
wherein the plurality of images represent a movement related to the current course or cycle by changing one of number, size, position, and density of the plurality of particles in each image.

2. (canceled)

3. The method of claim 1, wherein each of the plurality of images is displayed within a circle.

4. The method of claim 1, wherein the plurality of images contain grid dots as a background.

5. The method of claim 4, wherein the grid dots are displayed darker than the plurality of particles.

6. The method of claim 4, wherein the grid dots near a center of an image are displayed sharper than the grid dots on an outer part of the image.

7. The method of claim 4, wherein the grid dots are displayed within a three-dimensional water drop, and a change in a three-dimensional shape of the water drop are represented by varying intervals between the grid dots.

8. The method of claim 1, wherein one or more of the plurality of images contains text indicative of the current course or cycle.

9. The method of claim 8, wherein, when two or more of the plurality of images contain text, the text in the two or more images differ in lightness.

10. The method of claim 8, wherein the text is displayed within a three-dimensional water drop, and a change in a three-dimensional shape of the water drop is expressed by distorting a part of the text.

11. The method of claim 1, wherein one or more images each containing an icon associated with the current course or cycle and the plurality of images showing the plurality of particles are cyclically output.

12. The method of claim 11, wherein two or more images each containing the icon are sequentially output, and the icon in any image is more blurry than the icon in the preceding image.

13. The method of claim 12, wherein one or more first images showing the plurality of particles which are arranged around the blurred icon is output, and then one or more second images containing no icon and showing the plurality of particles is output, and
wherein the plurality of particles in each of the first and second images form a predetermined pattern to depict the operation related to the current course or cycle.

14. The method of claim 1, wherein one of the plurality of images and a remaining time are displayed together on a single screen.

15. The method of claim 1, wherein the plurality of images are represented such that the plurality of particles are arranged within a three-dimensional water drop.

16. The method of claim 15, wherein a three-dimensional shape of the water drop is expressed by surface gloss, shadow, or outline of the water drop.

17. The method of claim 16, wherein a change in a three-dimensional shape of the water drop is expressed by changing at least one of the following: surface gloss, shade, shadow, degree of particle scattering, and outline.

18. The method of claim 15, wherein the operation related to the current course or cycle is dynamically displayed by adding one or more second water drops smaller than the water drop or changing number, size, or position of the one or more second water drops.
